(19) United States
(12) Patent Application Publication
(10) Pub. No.: US 2012/0225227 A1
(43) Pub. Date: Sep. 6, 2012

(54) MULTI-LAYER HIGH TEMPERATURE FILMS, LINERS, AND COOKING BAGS

(75) Inventors: Joseph A. RADOSTA, Easton, PA (US); Michael D. SCHMAL, Orwigsburg, PA (US); Ernest E. BACHERT, Orwigsburg, PA (US)

(73) Assignee: M&Q IP LEASING, INC., Wilmington, DE (US)

(21) Appl. No.: 13/406,719

(22) Filed: Feb. 28, 2012

Related U.S. Application Data
(60) Provisional application No. 61/448,776, filed on Mar. 3, 2011.

(51) Int. Cl. B32B 1/02; B32B 27/08; B05D 1/36; B32B 27/36

(52) U.S. Cl. 428/35.2; 428/483; 428/216; 427/412.5

(57) ABSTRACT

A multi-layer, high temperature film comprising at least three layers produced by melt extrusion coating a high heat resistant copolyester thermoplastic elastomer (COPE) layer onto an amorphous polyethylene terephthalate (APET) layer of a co-extruded, biaxially oriented, polyester homopolymer film comprising a straight crystalline polyethylene terephthalate (PET) layer and the APET layer to form a three layer film. In another embodiment, a second intermediate layer of amorphous polyethylene terephthalate (APET) film is melt extrusion coated to an opposite side of the COPE layer of the three layer film, and a second layer of PET is connected to the second APET layer opposite the COPE layer to form a five layer film. In another embodiment, a second APET layer is connected to an opposite side of the PET layer of the three layer film, and a second COPE layer is melt extrusion coated to the second APET layer opposite the PET layer.

### CROSS-REFERENCE TO RELATED APPLICATIONS

This application claims the benefit of U.S. Provisional Application Ser. No. 61/448,776, filed Mar. 3, 2011, entitled “Multi-Layer High Temperature Films, Liners, and Cooking Bags,” which is incorporated herein by reference in its entirety.

### TECHNOLOGY FIELD

The present invention relates in general to films, and more particularly, to multi-layer high temperature films, and liners and bags formed from such films. Embodiments of the present invention are particularly well suited, but in no way limited, to food cooking applications, such as meat cooking bag applications.

### BACKGROUND

Current commercially available copolyester thermoplastic elastomers (e.g., COPE or TPE-E) materials that are suitable for meat cooking bag applications can be safely used at cooking temperatures up to 350 degree F. Degradation of materials occurs over time at higher cooking temperatures. Bags made from these resins may be FDA certified, may be tough (i.e., resistant to tear), may have low meat adhesion, and may be heat sealable. Limitations for bags made from these resins are: (a) high gas permeability (e.g., bags can't hold a vacuum); and (b) missed market segments where temperatures up to 400 degree F. are required.

Cooking bags may also be made from biaxially oriented PET film (also referred to as polyester homopolymer film) (e.g., Mylar® from DuPont). This material may hold up to 400 degree F. cooking temperatures, may hold a vacuum, and may be FDA certified. However, limitations of bags made from these materials include: weaknesses, including poor resistance to tear; and difficult sealability.

A recent development is the discovery of a higher heat resistant copolyester thermoplastic elastomer (e.g., Arnitel® by DSM) that is suitable for 400 degree F. cooking. It possesses the attributes listed above, except for its high gas permeability which prevents its use where food is to be stored under vacuum.

At present, there is an unsatisfied market segment that requires a multi-layer film and cooking bag having the following attributes:

suitable for 400 degree F.;

FDA certified for 400 degree F. food cooking use;

good toughness and tear resistance;

low adhesion to meat (bag won't stick to meat upon cooking);

easy to heat seal with strong seal strengths;

hold a vacuum for extended time periods.

### SUMMARY

Embodiments of the present invention address and overcome the above shortcomings and drawbacks, by providing multi-layer high temperature films that: are suitable for 400 degree F.; are FDA certified for 400 degree F. food cooking use; have good toughness and tear resistance; have low adhesion to meat; are easy to heat seal with strong seal strength; and are capable of holding a vacuum for extended time periods. This technology is particularly well-suited for, but by no means limited to, food service applications including for example, high temperature cooking of meats. Embodiments of the present invention also include liners, such as pan liners, made from such multi-layer high temperature films. Further embodiments of the present invention are directed to high temperature cooking bags comprised of multi-layer high temperature films that are capable of fully satisfying all of the above needs and requirements.

According to one embodiment of the invention, a three layer film structure is disclosed. The three layer film structure comprises: a straight crystalline polyethylene terephthalate (PET) film; an amorphous polyethylene terephthalate (APET) layer; and a higher heat resistant copolyester thermoplastic elastomer (COPE) layer. The APET layer is located between and connects the COPE layer and the PET layer. In one embodiment, the APET layer is a co-extruded APET layer and the COPE layer is an extrusion coated COPE layer.

According to one aspect of the invention, the first layer of copolyester thermoplastic elastomer (COPE) film is melt extrusion coated onto the second layer of amorphous polyethylene terephthalate (APET) film.

According to another aspect of the invention, the straight crystalline polyethylene terephthalate (PET) layer and the amorphous polyethylene terephthalate (APET) layer comprise a co-extruded, biaxially oriented, polyester homopolymer film. In some embodiments, the heat resistant copolyester thermoplastic elastomer (COPE) layer is melt extrusion coated onto the amorphous polyethylene terephthalate (APET) side of the co-extruded, biaxially oriented, polyester homopolymer film, thereby forming a three layer film.

According to another embodiment of the invention, a five layer film structure is disclosed. The five layer film structure comprises: a clear PET film, a co-extruded APET layer; an extrusion coated higher heat resistant COPE layer; a co-extruded APET layer; and a clear PET film. This exemplary five layer film structure may comprise: a middle layer comprising a copolyester thermoplastic elastomer (COPE) film; a first intermediate layer comprising an amorphous polyethylene terephthalate (APET) film, a first side of the first intermediate layer connected to a first side of the middle layer; a first outer layer comprising a straight crystalline polyethylene terephthalate (PET) film, a first side of the first outer layer connected to a second side of the first intermediate layer; a second intermediate layer comprising an amorphous polyethylene terephthalate (APET) film, a first side of the second intermediate layer connected to a second side of the middle layer; and a second outer layer comprising a straight crystalline polyethylene terephthalate (PET) film, a first side of the second outer layer connected to a second side of the second intermediate layer.

According to another embodiment of the invention, another five layer film structure is disclosed. This embodiment of the five layer film structure comprises: an extrusion coated higher heat resistant COPE layer; a co-extruded APET layer; a clear PET film, a co-extruded APET layer; and an extrusion coated higher heat resistant COPE layer. This exemplary five layer film structure may comprise: a middle layer comprising a straight crystalline polyethylene terephthalate (PET) film; a first intermediate layer comprising an amorphous polyethylene terephthalate (APET) film, a first side of the first intermediate layer connected to a first side of the middle layer; a first outer layer comprising a copolyester thermoplastic elastomer (COPE) film, a first side of the first outer layer connected to a second side of the first intermediate layer; a second intermediate layer comprising an amorphous polyethylene terephthalate (APET) film, a first side of the second intermediate layer connected to a second side of the middle layer; and a second outer layer comprising a copolyester thermoplastic elastomer (COPE) film, a first side of the second outer layer connected to a second side of the second intermediate layer. This five layer film structure results in a balanced structure that is well suited for heat sealing and facilitates formation of bags having a gusseted bottom.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an exemplary embodiment of a multi-layer film comprising a three layer film suitable for high temperature applications;

FIG. 2 illustrates an exemplary melt extrusion coating technique for producing the multi-layer film of FIG. 1;

FIG. 3 shows an exemplary embodiment of a multi-layer film comprising a five layer film suitable for high temperature applications;

FIG. 4 shows another exemplary embodiment of a five layer film suitable for high temperature applications;

FIGS. 5A and 5B show a gusseted bag formed using the five layer film structure of FIG. 4; and

FIG. 6 show a Table listing physical testing results on exemplary multi-layer films.

### DETAILED DESCRIPTION OF ILLUSTRATIVE EMBODIMENTS

The above problems in the prior art have motivated the creation of a multi-layer high temperature film having the characteristics of: being suitable for use in 400 degree F. temperature applications; being FDA certified for 400 degree F. food cooking use; having good toughness and tear resistance; exhibiting low adhesion to meat; being easy to heat seal with resultant strong seal strengths; holding a vacuum for extended time periods (low gas permeability). In addition, embodiments of the present invention are directed to liners, such as pan liners, made from such multi-layer high temperature films. Other embodiments are directed to cooking bags made from such multi-layer high temperature films.

As used herein, the following terms have the following meaning. Good toughness and tear resistance means having a Tear Propagation Force greater than about 100 gms-force and Ultimate Tensile Elongation greater than about 50%. Low adhesion to meat means substantially no meat or meat protein visually sticking or adhering to the film after it is stripped away from the meat after cooking at 400 degree F. for two hours or more. Easy to heat seal means the film has at least a 25 degree F. heat seal window, heat seal window being defined as the spread between the lowest temperature and highest temperature at which the film can be heat sealed. Resultant strong seal strengths means greater than about 6.0 lbs-force/in. Holding a vacuum may be measured by heat sealing, for example, a whole chicken under vacuum in a bag formed from a multi-layer film according to embodiments of the invention, and after one month the bag is still under vacuum as determined visually by trying to pull the bag away from the chicken. Extended time periods means about three weeks or more.

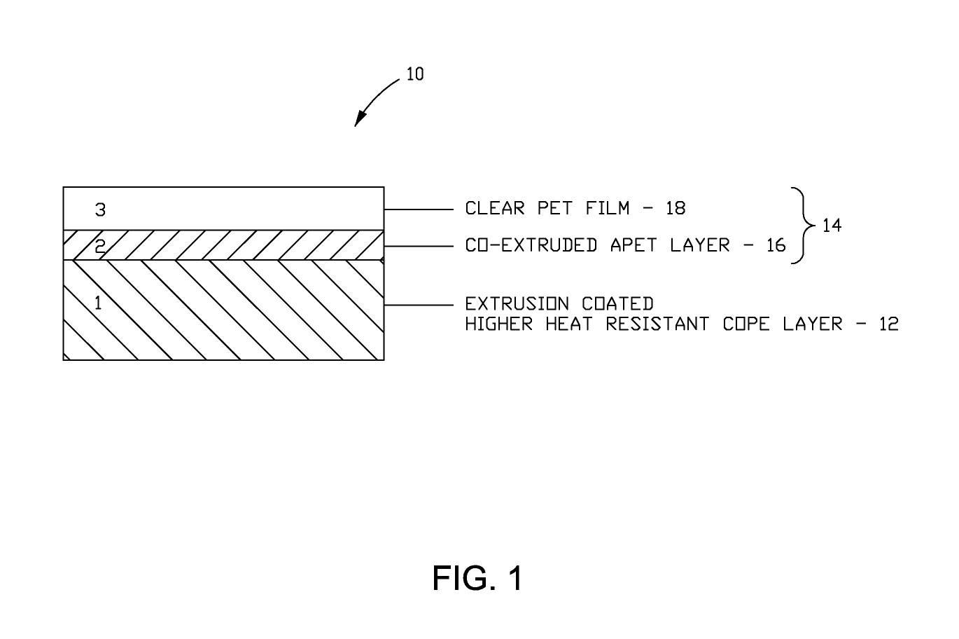

FIG. 1 is an exemplary multi-layer, high temperature film comprising a three layer film. As shown in FIG. 1, multi-layer, high temperature film 10 comprises: a high heat resistant copolyester thermoplastic elastomer (COPE) layer 12 (a first layer); a straight crystalline polyethylene terephthalate (PET) layer 18 (a third layer); and a layer that is amorphous PET 16 (a second or intermediate layer) located between the COPE layer 12 and the PET layer 18.

In one embodiment, multi-layer, high temperature film 10 comprises: a high heat resistant copolyester thermoplastic elastomer layer 12; and a commercially available co-extruded, biaxially oriented, polyester homopolymer film 14 comprising one layer that is straight crystalline PET layer 18 and another layer that is amorphous PET (APET) 16. The PET and APET layers naturally adhere to each other when coextruded together. In one embodiment, the multi-layer, high temperature film 10 is produced by melt extrusion coating the high heat resistant copolyester thermoplastic elastomer (COPE) layer 12 onto the amorphous PET side 16 of the co-extruded, biaxially oriented, polyester homopolymer film 14, thereby forming a three layer film 10.

Table 1 shows preferred materials and layer thickness ranges for the three layer film embodiment of FIG. 1.

TABLE 1

| | | THICKNESS |
|---|---|---|
| LAYER | MATERIALS | RANGES (mils) |
| 1^{st} Layer | copolyester thermoplastic elastomer | 0.2-2 |
| (12) | (COPE) | |
| ^{2nd} Layer | amorphous polyethylene terephthalate | 0.1-1 |
| (16) | (APET) | |
| 3^{rd} Layer | straight crystalline polyethylene | 0.2-2 |
| (18) | terephthalate (PET) | |

The copolyester thermoplastic elastomer (COPE) layer 12 generally has the characteristics of: high temperature, high heat resistant, 400 degree F. cooking, non-stick to food, FDA certified for food content applications, good toughness, and good sealability. The straight crystalline PET layer 18 generally has characteristics of: good barrier properties that allow the multi-layer film to hold a vacuum, and avoids seal stretch (since the PET layer 18 generally has a melting point about 500 degree F. it does not melt during the heat seal process, whereas the COPE layer 12 has a melting point closer to about 410 degrees F. and melts to form the seal having good adhesion without melting of the PET layer 18).

For example, during heat sealing the multi-layer film may be folded such that the COPE layer 12 is in contact with the COPE layer 12 on the inside of the fold, and the PET layer 18 is on the outside of the folded film. Then, a heat seal may be applied to the exterior layer—i.e., the PET layer 18—which transmits the heat through the film and causes the two COPE layers 12 to melt together and heat seal (while the PET layer 18 having a higher melting point does not melt). This helps avoid stretching in the seal and helps ensure a good/strong seal.

The amorphous PET 16 layer serves to bond the COPE layer 12 and the PET layer 18. The amorphous PET 16 layer has a broad softening range around 400 degree F. (e.g., non-crystalline in a temperature range below and above 400 degree F.), which prevents this layer from being used on its own as the outside layer of a heat sealed film.

Table 2 shows alternative compositions and layer thickness ranges for alternative embodiments of a three layer high temperature film similar to the embodiment of FIG. 1.

TABLE 2

| | | THICKNESS |
|---|---|---|
| LAYER | ALTERNATE MATERIALS | RANGES (mils) |
| 1^{st} Layer | — | 0.2-2 |
| (12) | | |
| ^{2nd} Layer | Other Seal Layer Materials | 0.1-1 |
| (16) | | |
| 3^{rd} Layer | Polyamide Homopolymer | 0.2-2 |
| (18) | Polyamide Copolymers | |
| | MQ 501 | |

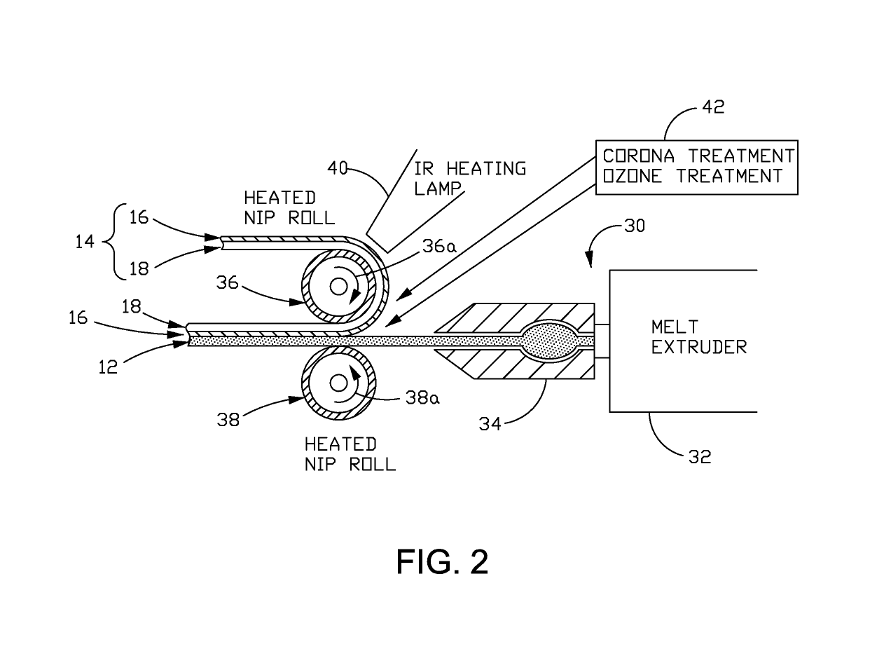

FIG. 2 illustrates exemplary tooling and an exemplary extrusion coating technique that may be employed to produce the three layer film 10 of FIG. 1. As shown in FIG. 2, a hot melt extruder 30 may be used to produce a melt extrusion coated layer of high heat resistant COPE layer 12. The hot melt extruder 30 may be of conventional design and may include a conveying system 32, which transports the material and imparts a degree of distributive and dispersive mixing, and a die system 34, which forms the material into the required shape. The extruder 30 typically includes a feed hopper, a cylindrical and stationary barrel, a screw rotatably disposed in the barrel, and a screw drive unit for rotating the screw (all not shown). Heat required to melt or fuse the materials is typically supplied by the heat generated by friction as the material is sheared between the rotating screws and the sidewall of the barrel. Also, heaters (electric, liquid, etc.) (not shown) may be provided on the barrel to help heat and melt the material.

After exiting the die system 34, the COPE layer 12 feeds into opposing nip rollers 36, 38. As shown, the nip rollers may include an upper nip roller 36 and a lower nip roller 38. In the illustrated embodiment, the upper nip roller 36 rotates clockwise (arrow 36a) and the lower nip roller 38 rotates counterclockwise (arrow 38a). The nip rollers 36, 38 may be heated nip rollers.

As shown in FIG. 2, a clear PET film 18 with a co-extruded APET layer 16 may be fed over the upper nip roller 36, between the upper and lower nip rollers 36, 38, and onto the COPE layer 12. As described above, this film may comprise a co-extruded, biaxially oriented, polyester homopolymer film 14 comprising a layer of straight crystalline PET 18 and a layer of amorphous PET 16. As shown, the co-extruded APET layer 16 contacts and bonds to the COPE layer 12, which is in a molten state at the time of bonding. For example, contact between the molten COPE layer 12 and the inside amorphous PET layer 16 substantially melts and then solidifies the layers together.

As shown, a heating device 40 may be positioned proximate the upper nip roller 36 to heat the polyester homopolymer film 14 and its co-extruded APET layer 16. The heating device 40 may include an IR heating lamp.

As shown in FIG. 2, the multi-layer film formation may include surface treatment system 42. For example, in some embodiments the surface treatment system 42 may include corona treatment, which is a surface treatment process that improves the bonding characteristics of the films—e.g., bonding characteristics of the COPE layer 12 and APET layer 16. This surface treating modifies surfaces of the film(s) to improve adhesion.

Conventional corona discharge equipment may be used including, for example, a high-frequency power generator, a high-voltage transformer, a stationary electrode, and a treater ground roll. The corona treatment system 42 converts standard utility electrical power into higher frequency power which is then supplied to the treater station. The treater station applies this power through ceramic or metal electrodes over an air gap onto the film surface.

In some embodiment, the surface treatment system 42 may include ozone treatment to improve the bonding characteristics of the films. For example, adhesion between the polymer films—i.e., the COPE layer 12 and the APET layer 16—may be enhanced by treating the surface of the films with ozone before the two films are brought together. Other embodiments may include a surface treatment system 42 having both corona and ozone treatment.

Alternatively, the multi-layer high temperature film may be formed using co-extrusion techniques.

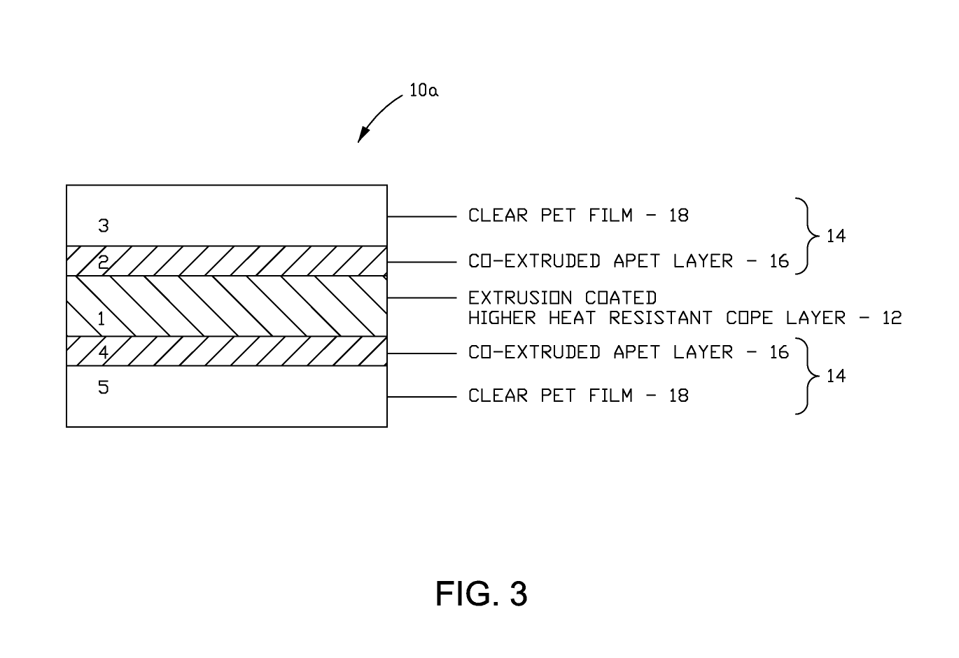

FIG. 3 is an exemplary multi-layer, high temperature film comprising a five layer film. As shown in FIG. 3, multi-layer, high temperature film 10a comprises: a high heat resistant copolyester thermoplastic elastomer layer 12 (a first layer) as the middle or core layer of the multi-layer film 10a; straight crystalline PET layers 18 as outer most layers (a third layer and a fifth layer); and layers of amorphous PET 16 as intermediate layers (a second layer and a fourth layer) located between the middle COPE layer 12 and the outer PET layers 18. In one embodiment, an extrusion coated higher heat resistant COPE layer 12 may be sandwiched between two co-extruded, biaxially oriented, polyester homopolymer films 14. Each co-extruded, biaxially oriented, polyester homopolymer film 14 comprises one layer that is straight crystalline PET 18 and another layer that is amorphous PET 16. The amorphous PET layers 16 are in contact with and bonded to the COPE layer 12.

The multi-layer film structure of FIG. 3 results in a film having good toughness and high barrier properties. The embodiment also results in a balanced multi-layer film having amorphous PET layer 16 and straight crystalline PET layer 18 on both sides of the heat resistant COPE layer 12. A balanced structure—i.e., a multi-layer film having corresponding layers of same material and thickness on both sides of the core layer—results in equal forces on both sides thereby reducing/preventing curling of the multi-layer film. In addition, the barrier properties and the toughness of the multi-layer film of FIG. 3 are improved over the multi-layer film of FIG. 1 due to the extra layers of amorphous PET 16 and straight crystalline PET 18. Bags may be formed using the multi-layer, high temperature film 10a of FIG. 3 by, for example, sewing the film together using sewing thread.

Table 3 shows preferred materials and layer thickness ranges for the five layer film embodiment of FIG. 3.

TABLE 3

| | | THICKNESS |
|---|---|---|
| LAYER | MATERIALS | RANGES (mils) |
| 1^{st} Layer | copolyester thermoplastic elastomer | 0.2-2 |
| (12) | (COPE) | |
| 2^{nd} & 4^{th} | amorphous polyethylene terephthalate | 0.1-1 |
| Layer (16) | (APET) | |
| 3^{rd} & 5^{th} | straight crystalline polyethylene | 0.2-2 |
| Layer (18) | terephthalate (PET) | |

Table 4 shows alternative compositions and layer thickness ranges for alternative embodiments of a five layer high temperature film similar to the embodiment of FIG. 3.

TABLE 4

| | | THICKNESS |
|---|---|---|
| LAYER | ALTERNATE MATERIALS | RANGES (mils) |
| 1^{st} Layer | — | 0.2-2 |
| (12) | | |
| 2^{nd} & 4^{th} | Other Seal Layer Materials | 0.1-1 |
| Layer (16) | | |
| 3^{rd} & 5^{th} | Polyamide Homopolymer | 0.2-2 |
| Layer (18) | Polyamide Copolymers | |
| | MQ 501 | |

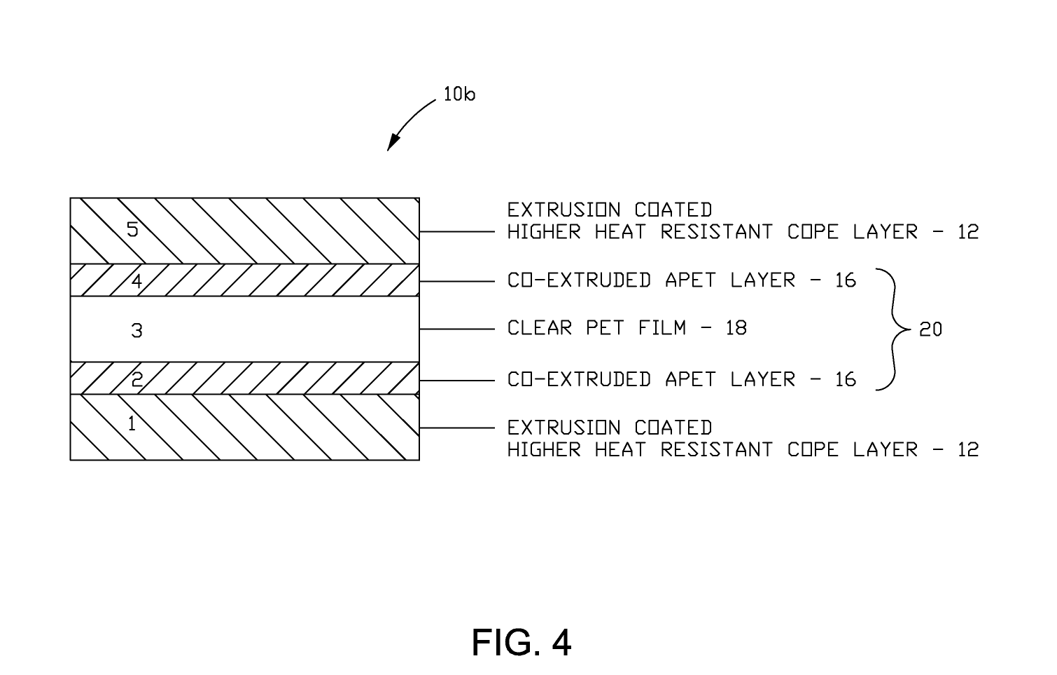

FIG. 4 is another exemplary five layer, high temperature film. As shown in FIG. 4, multi-layer, high temperature film 10b comprises: high heat resistant copolyester thermoplastic elastomer layers 12 (a first layer and a fifth layer) as the outer most layers of the multi-layer film 10b; a straight crystalline PET layer 18 (a third layer) as the middle or core layer of the multi-layer film 10b; and layers of amorphous PET 16 as intermediate layers (a second layer and fourth layer) located between the outer COPE layers 12 and the middle or core PET layer 18. In one embodiment, both sides of the co-extruded, biaxially oriented, polyester homopolymer film may have APET layers 16 and an intermediate PET layer 18, thus comprising multi-layer 20. Multi-layer 20 may comprise a commercially available film, for example. As shown, the higher heat resistant COPE outside layers 12 may be formed by extrusion coating onto each side of the co-extruded PET film of multi-layer 20.

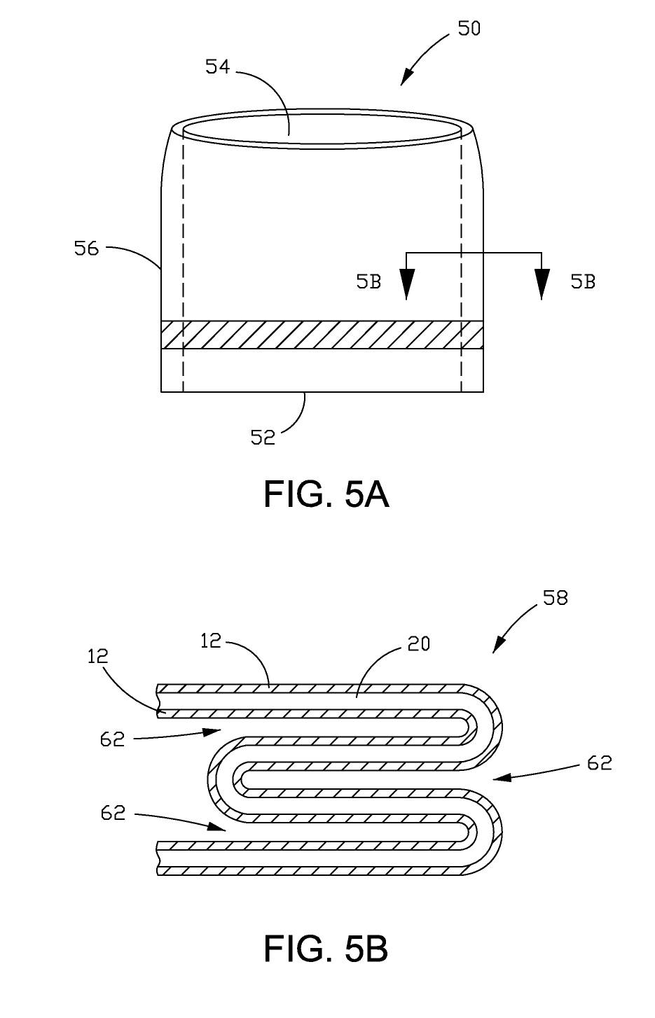

The embodiment illustrated in FIG. 4 produces a balanced structure that may be very useful, for example, for heat sealing a gusseted bag, as illustrated in FIGS. 5A and 5B. The multi-layer film structure of FIG. 4 results in a film having good heat sealing properties. This film having an extrusion coated higher heat resistant COPE layer as the two outer layers facilitates heat sealing and formation, for example, of a gusseted bag, as explained in more detail below with reference to FIGS. 5A and 5B.

Table 5 shows preferred materials and layer thickness ranges for the five layer film embodiment of FIG. 4.

TABLE 5

| | | THICKNESS |
|---|---|---|
| LAYER | MATERIALS | RANGES (mils) |
| 1^{st} and 5^{th} | copolyester thermoplastic elastomer | 0.2-2 |
| Layer (12) | (COPE) | |
| 2^{nd} & 4^{th} | amorphous polyethylene terephthalate | 0.1-1 |
| Layer (16) | (APET) | |
| 3^{rd} Layer | straight crystalline polyethylene | 0.2-2 |
| (18) | terephthalate (PET) | |

Table 6 shows alternative compositions and layer thickness ranges for alternative embodiments of a five layer high temperature film similar to the embodiment of FIG. 4.

TABLE 6

| | | THICKNESS |
|---|---|---|
| LAYER | ALTERNATE MATERIALS | RANGES (mils) |
| 1^{st} and 5^{th} | — | 0.2-2 |
| Layer (12) | | |
| 2^{nd} & 4^{th} | Other Seal Layer | 0.1-1 |
| Layer (16) | (Tie Layer) Materials | |
| 3^{rd} Layer | Polyamide Homopolymer | 0.2-2 |
| (18) | Polyamide Copolymers | |
| | MQ 501 | |

Embodiments of the present invention are directed to bags made from such multi-layer high temperature films illustrated and described with reference to FIGS. 1, 3 and 4; for example, high temperature cooking bags such as those disclosed in U.S. Pat. No. 7,709,069, entitled High Temperature Venting Bags, and U.S. Patent Application Publication No. 2008/0247683, entitled High Temperature Stand-Up Oven Bag, which are incorporated herein by reference in their entirety.

FIGS. 5A and 5B show a gusseted bag 50 that may be formed using the multi-layer high temperature film of FIG. 4. As shown, the bag 50 includes a closed bottom end 52, an open top end 54, and a side wall 56 extending between the closed bottom end 52 and the open top end 54. The closed bottom end 52 may be formed using heat seal techniques.

In some embodiments, the bottom of the bag may be formed having a gusset 58. In some embodiments, the sides of the bag may be formed into a gusset (not shown). The gusset 58 may be formed using heat seal techniques. FIG. 5B shows an enlarged cross-sectional view of a bottom end portion of bag 50 having a gusset 58. The 5 layer film of FIG. 4 is folded inward to form a fold, as shown in FIG. 5B. When folded, the two outer most layers of the 5 layer film come into contact with one another. The outer most layers comprise COPE layers 12, which are readily heat sealable to one another. Once heat sealed, the gusset 58 includes multiple heat seals 62. This 5 layer film and configuration having outer COPE layers 12 allows for easy heat sealing and results in a gusset 58 and closed bottom end 52 having a high seal strength.

In addition, embodiments of the present invention are directed to liners made from such multi-layer high temperature films illustrated and described with reference to FIGS. 1, 3 and 4. For example, pan liners such as those disclosed in U.S. Pat. No. 7,163,120, entitled Contour Fit Pan Liner For A Food Service Pan, which is incorporated herein by reference in its entirety.

Working example of one embodiment of a new extrusion coated multi-layer film:

An exemplary three layer film was produced by melt extrusion coating a high heat resistant copolyester thermoplastic elastomer (COPE) (e.g., Arnitel® X06111) onto an amorphous PET (APET) side of a co-extruded, biaxially oriented, polyester homopolymer film comprising one layer that is straight crystalline PET and another layer that is APET (e.g., Mylar® 850H film). In this example, the Arnitel® X06111 layer was an approximately 1.92 mils in thickness and the Mylar® 850H was an approximately 0.48 mil film, which produced a three layer structure having a total film thickness of approximately 2.4 mils. See e.g., FIG. 1 for exemplary three layer film structure.

Experimental Results for Exemplary Cooking Bag Trials:

Bag Preparation and Cooking Procedures:

Several cooking bags were prepared using a new extrusion coated three layer film structure, as described above with reference to FIG. 1. Chicken breasts were placed into these bags and the bags were sealed. A small vent was cut into the top of each bag. The chicken breast filled bags were then placed in a 400 degree F. preheated oven and cooked for a period of about 2 hours.

Cooking Results:

The cooked chickens browned appropriately and the bags did not show any signs of deterioration due to cooking at oven temperatures between 400 degree F. and 410 degree F. for approximately 2 hours. There was no meat adhesion onto the bag surfaces. The seals were still strong and no leaks were observed. Also, there was no delamination between any of the layers of the multi-layered film.

Physical Testing Results on Films:

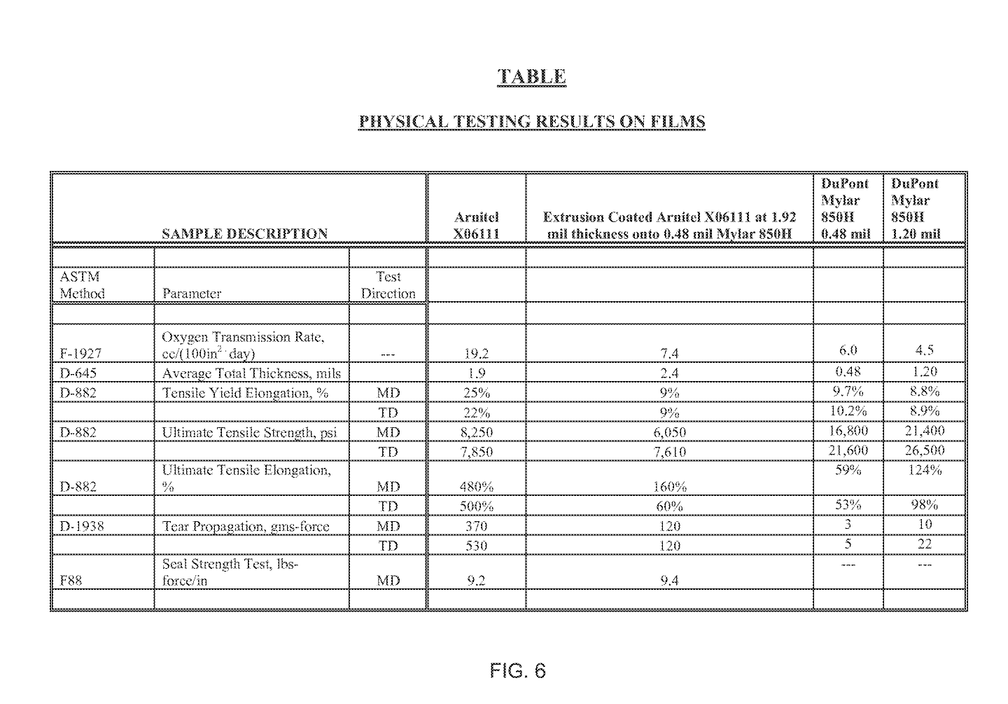

FIG. 6 is a Table that shows the test results of various properties of four films, including the new extrusion coated three layer film structure of FIG. 1; a mono-layer Arnitel® X06111 film; and two thicknesses of a Mylar® 850H film.

As illustrated in the Table of FIG. 6, when compared to the mono-layer Arnitel® X06111 film, the new extrusion coated three layer film structure was successful in reducing the Oxygen Transmission Rate by close to a factor of 3. This extrusion coated film also is capable of holding a vacuum for extended periods of time, since it comes very close to matching the Oxygen Transmission Rates for both thicknesses of Mylar® 850H films. Preferably, Oxygen Transmission Rate is less than about 10 cc/(100 square inches/day)

As also shown in the Table of FIG. 6, toughness and tear properties of the new extrusion coated three layer film structure, as measured by ultimate tensile elongation and tear propagation respectively, show the improvements that can be achieved over the Mylar® 850H films.

Still further, the new extrusion coated three layer film structure exhibits excellent seal strength properties and is easy to seal over a broad seal temperature window. The sealability and seal strength properties of the new extrusion coated three layer film are similar to the mono-layer Arnitel® X06111 film.

Importance of Heat Activated Layer on Polyester Film:

All attempts to extrusion coat a high heat resistant copolyester thermoplastic elastomer (e.g., Arnitel® X06111) onto mono-layer biaxially oriented, polyester homopolymer film (e.g. Mylar® 800) were unsuccessful. The extrusion coated layer easily delaminated from the Mylar® layer when a sealed bag, made from the two layer film structure, was stressed. All of the following attempts at improving the adhesion between the two layers failed to show any improvement in preventing delamination:
Apply IR heat to the Mylar® film surface just before the extrusion coating operation;
Increase the melt temperature of the Arnitel® X06111 to its maximum permissible value;
Activate the Mylar® surface by various combinations of corona and ozone treatments;
Combinations of all of the above.

Successful results were obtained, however, when the extrusion coating substrate included a co-extruded, biaxially oriented, polyester homopolymer film; where one layer is straight crystalline PET and the other layer is amorphous PET. In one embodiment, Arnitel® X06111 was melt extrusion coated onto the amorphous PET side of the Mylar® 850H film. The resulting three layer structure did not delaminate when subjected to cooking and bag burst tests.

Further, it was discovered that application of IR heating to the Mylar® film surface and using a relatively high melt temperature (e.g., around 530 degree F.) for the Arnitel® X06111 further improved the adhesion between this substrate and the Arnitel® X06111 and was sufficient to obtain excellent adhesion between the layers.

The fact that the individual layers of this multi-layer film (e.g., COPE layer 12 and amorphous PET 16) did not delaminate during high temperature applications was somewhat unexpected. The inventors believe that this phenomenon is a result of one or more of the following. It is believed that the amorphous polyester layer 16, being very, very, very thin, helps avoid delamination because thin layers usually have higher surface energies than thicker layers. When one is trying to bond two layers together, usually one of the two layers is as thin as possible, resulting in a stronger adhesion between the two. It is also believed that loading up the temperature of the extrusion coating as hot as possible leads to improved bonding between layers; for example, one or more of: heating the nip rolls, preheating the layer of amorphous material with an infra-red lamp, etc. It is also believed that in an oven, amorphous polyester layer 16 softens up and become somewhat fluid, but since this is such a thin layer, since it's so viscous, there is still adhesion even though it's melted. Another explanation is the surface tension between the adjacent layers. Still another explanation is that during the heat extrusion process, the materials of the two layers merged into one another forming a slightly different polymer.

Use of a bio-based material, such as Arnitel® X06111, as the high heat resistant copolyester thermoplastic elastomer provides further benefits. It is believed that this application discloses the first use of a bio-based material, for example, a based material polymerized from rapeseed (canola oil) for use in an “ovenable cooking” environment (e.g., 400 degree F. or higher). The reason for this is that most bio-based materials can not withstand 400 degree F., and also most cannot achieve FDA approval for food contact at 400 degree F. Therefore, identification and use of the specific grades of bio-based high heat resistant copolyester thermoplastic elastomer, such as Arnitel, for formation of multi-layer high temperature films, pan liners, and oven bags is another novel feature of the present invention. The properties and characteristics of a Bio-based COPE are very similar to a petroleum based COPE.

In accordance with embodiments of the present invention, the multi-layer, high temperature film, and cooking bags produced from such films, provide the following additional advantages and benefits:
Suitable for 400 degree F. applications;
FDA certified for 400 degree F. cooking applications;
Good toughness and tear resistance;
Low adhesion to meat upon high temperature cooking applications;
Easy to heat seal with resulting strong seal strengths;
Holds a vacuum for extended time periods; and
Reduces clean up time and provides ease of cleaning.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims cover be construed to all such equivalent variations as fall within the true spirit and scope of the invention.

What is claimed:

1. A multi-layer, high temperature film comprising:
a first layer comprising a copolyester thermoplastic elastomer (COPE) film;
a third layer comprising a straight crystalline polyethylene terephthalate (PET) film; and
a second layer comprising an amorphous polyethylene terephthalate (APET) film located between and connecting the copolyester thermoplastic elastomer (COPE) layer and the straight crystalline polyethylene terephthalate (PET) layer.

2. The multi-layer, high temperature film of claim 1, wherein the first layer of copolyester thermoplastic elastomer (COPE) film is melt extrusion coated onto the second layer of amorphous polyethylene terephthalate (APET) film.

3. The multi-layer, high temperature film of claim 1, wherein the straight crystalline polyethylene terephthalate (PET) layer and the amorphous polyethylene terephthalate (APET) layer comprise a co-extruded, biaxially oriented, polyester homopolymer film.

4. The multi-layer, high temperature film of claim 3, produced by melt extrusion coating the copolyester thermoplastic elastomer (COPE) layer onto the amorphous polyethylene terephthalate (APET) side of the co-extruded, biaxially oriented, polyester homopolymer film, thereby forming a three layer film.

5. The multi-layer, high temperature film of claim 1, wherein:
the copolyester thermoplastic elastomer (COPE) layer comprises a film thickness of about 0.2 mil to about 2 mil;
the amorphous polyethylene terephthalate (APET) layer comprises a film thickness of about 0.1 mil to about 1 mil; and
the straight crystalline polyethylene terephthalate (PET) layer comprises a film thickness of about 0.2 mil to about 2 mil.

6. The multi-layer, high temperature film of claim 1, further comprising:
a fifth layer comprising a straight crystalline polyethylene terephthalate (PET) film; and
a fourth layer comprising an amorphous polyethylene terephthalate (APET) film located between and connecting the first layer of copolyester thermoplastic elastomer (COPE) film and the fifth layer of straight crystalline polyethylene terephthalate (PET) film, the fourth and fifth layers located on an opposite side of the copolyester thermoplastic elastomer (COPE) layer from the second and third layers.

7. The multi-layer, high temperature film of claim 6, wherein the first layer of copolyester thermoplastic elastomer (COPE) film is melt extrusion coated onto the fourth layer of amorphous polyethylene terephthalate (APET) film.

8. The multi-layer, high temperature film of claim 1, further comprising:
a fifth layer comprising a copolyester thermoplastic elastomer (COPE) film; and
a fourth layer comprising an amorphous polyethylene terephthalate (APET) film located between and connecting the third layer of straight crystalline polyethylene terephthalate (PET) film and the fifth layer of copolyester thermoplastic elastomer (COPE) film, the fourth and fifth layers located on an opposite side of the third layer of straight crystalline polyethylene terephthalate (PET) film from the second and third layers.

9. The multi-layer, high temperature film of claim 8, wherein the fifth layer of copolyester thermoplastic elastomer (COPE) film is melt extrusion coated onto the fourth layer of amorphous polyethylene terephthalate (APET) film.

10. A multi-layer, high temperature film comprising:
a middle layer comprising a copolyester thermoplastic elastomer (COPE) film;
a first intermediate layer comprising an amorphous polyethylene terephthalate (APET) film, a first side of the first intermediate layer connected to a first side of the middle layer;
a first outer layer comprising a straight crystalline polyethylene terephthalate (PET) film, a first side of the first outer layer connected to a second side of the first intermediate layer;
a second intermediate layer comprising an amorphous polyethylene terephthalate (APET) film, a first side of the second intermediate layer connected to a second side of the middle layer; and
a second outer layer comprising a straight crystalline polyethylene terephthalate (PET) film, a first side of the second outer layer connected to a second side of the second intermediate layer.

11. The multi-layer, high temperature film of claim 10, wherein the middle layer of copolyester thermoplastic elastomer (COPE) film is melt extrusion coated onto the first and second intermediate layers of amorphous polyethylene terephthalate (APET) film.

12. A multi-layer, high temperature film comprising:
a middle layer comprising a straight crystalline polyethylene terephthalate (PET) film;
a first intermediate layer comprising an amorphous polyethylene terephthalate (APET) film, a first side of the first intermediate layer connected to a first side of the middle layer;
a first outer layer comprising a copolyester thermoplastic elastomer (COPE) film, a first side of the first outer layer connected to a second side of the first intermediate layer;
a second intermediate layer comprising an amorphous polyethylene terephthalate (APET) film, a first side of the second intermediate layer connected to a second side of the middle layer; and
a second outer layer comprising a copolyester thermoplastic elastomer (COPE) film, a first side of the second outer layer connected to a second side of the second intermediate layer.

13. The multi-layer, high temperature film of claim 12, wherein the first and second outer layers of copolyester thermoplastic elastomer (COPE) film are melt extrusion coated onto the first and second intermediate layers of amorphous polyethylene terephthalate (APET) film.

14. The multi-layer, high temperature film of claim 12, further comprising a cooking bag formed from the multi-layer, high temperature film, the cooking bag further comprising:
a closed bottom end;
one or more side walls extending upward from the closed bottom end;
an open top end formed by a distal end of the one or more side walls; and
a gusset formed at the closed bottom end by heat sealing the two outer layers of copolyester thermoplastic elastomer (COPE) film.

15. A method of forming a multi-layer, high temperature film, the method comprising:
providing a layer of a copolyester thermoplastic elastomer (COPE) film;
melt extrusion coating a first side of the copolyester thermoplastic elastomer (COPE) layer onto a first side of a layer of an amorphous polyethylene terephthalate (APET) film; and
connecting a first side of a layer of a straight crystalline polyethylene terephthalate (PET) film to a second side of the amorphous polyethylene terephthalate (APET) layer.

16. The method of claim 15, further comprising:
melt extrusion coating a second side of the copolyester thermoplastic elastomer (COPE) layer onto a first side of a second layer of amorphous polyethylene terephthalate (APET) film; and
connecting a second layer of a straight crystalline polyethylene terephthalate (PET) film to a second side of the second amorphous polyethylene terephthalate (APET) layer.

17. The method of claim 15, further comprising:
connecting a first side of a second layer of amorphous polyethylene terephthalate (APET) film to a second side of the straight crystalline polyethylene terephthalate (PET) layer; and
melt extrusion coating a second copolyester thermoplastic elastomer (COPE) layer onto a second side of the second layer of amorphous polyethylene terephthalate (APET) film.

18. The method of claim 15, further comprising:
heating the amorphous polyethylene terephthalate (APET) layer prior to the step of melt extrusion coating.

19. The method of claim 18, wherein the step of heating the amorphous polyethylene terephthalate (APET) layer comprises one or more of: heating the amorphous polyethylene terephthalate (APET) layer using an IR heating lamp; and heating the amorphous polyethylene terephthalate (APET) layer using heated nip rollers.

20. The method of claim 15, further comprising:
surface treating one or more of the amorphous polyethylene terephthalate (APET) layer and the copolyester thermoplastic elastomer (COPE) layer prior to the step of melt extrusion coating.

21. The method of claim 20, wherein the step of surface treating comprises one or more of: surface treating one or more of the amorphous polyethylene terephthalate (APET) layer and the copolyester thermoplastic elastomer (COPE) layer with corona treatment; and surface treating one or more of the amorphous polyethylene terephthalate (APET) layer and the copolyester thermoplastic elastomer (COPE) layer with ozone treatment.

22. The method of claim 15, wherein:
the copolyester thermoplastic elastomer (COPE) layer comprises a film thickness of about 0.2 mil to about 2 mil;
the amorphous polyethylene terephthalate (APET) layer comprises a film thickness of about 0.1 mil to about 1 mil; and
the straight crystalline polyethylene terephthalate (PET) layer comprises a film thickness of about 0.2 mil to about 2 mil.
